(19) United States
(12) Patent Application Publication
(10) Pub. No.: US 2006/0239527 A1
(43) Pub. Date: Oct. 26, 2006

(54) Three-dimensional cardiac border delineation in medical imaging

(76) Inventors: Sriram Krishnan, Exton, PA (US); Dorin Comaniciu, Princeton Jct., NJ (US); Xiang Zhou, Exton, PA (US); Bogdan Georgescu, Highland Park, NJ (US); Helene Houle, Sunnyvale, CA (US); R. Bharat Rao, Berwyn, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/351,060

(22) Filed: Feb. 9, 2006

Related U.S. Application Data
(60) Provisional application No. 60/674,624, filed on Apr. 25, 2005.

(51) Int. Cl. G06K 9/00

(52) U.S. Cl. 382/128

(57) ABSTRACT

Three-dimensional cardiac border is delineated in medical imaging. A view is labeled, such as identifying a two-dimensional view as an apical four-chamber view. A three-dimensional border is detected as a function of the view label. For example, the view is associated from a plane through a volume and a known orientation relative to the heart. Labeling the view indicates the orientation of the heart in the scanned volume. By determining the orientation of the heart, border detection processes may be simplified or assisted.

### RELATED APPLICATIONS

The present patent document claims the benefit of the filing date pursuant to 35 U.S.C. §119(e) of Provisional U.S. Patent Application Ser. No. 60/674,624, filed Apr. 25, 2005, which is hereby incorporated by reference.

### BACKGROUND

This present invention relates to determining borders, such as cardiac or heart borders, in medical imaging. A number of different imaging modalities can be used to study or diagnose the heart, including ultrasound, MRI, CT, nuclear medicine, and angiography.

To assess cardiac function, the heart is represented in one or more images. By viewing images of the heart through a portion or an entire heart cycle, operation of the heart may be analyzed. The images are generated as three-dimensional representations or in two-dimensional planes. For example, a volume is sliced in an arbitrary plane to generate a two-dimensional image associated with that plane (i.e., a planar reconstruction is generated). Two or three orthogonal planes provide multiplanar reconstruction of the imaged volume. A three-dimensional representation of the volume may also be viewed.

For quantification from cardiac images, the heart border, such as the endocardium and/or epicardium, is detected and may be tracked through a sequence of images. The border is detected based on user assistance. The user manually identifies multiple landmark points, such as the mitral annulus, apex, and aortic outflow track, of the heart. These landmarks points may be more readily identified by the user by viewing two-dimensional images of particular views of the heart, such as the apical four-chamber view. The user may use the planar reconstructions of the volume for manual indication of the landmark points. An algorithm then determines the border using the landmark points. The detected border is segmented or otherwise used for quantification. However, manually inputting landmark points is time consuming.

### BRIEF SUMMARY

By way of introduction, the preferred embodiments described below include methods, computer readable media and systems for three-dimensional cardiac border delineation in medical imaging. A view is labeled, such as identifying a two-dimensional view as an apical four-chamber view. A three-dimensional border is detected as a function of the view label. For example, the view is associated from a plane through a volume and a known orientation relative to the heart. Labeling the view indicates the orientation of the heart in the scanned volume. By determining the orientation of the heart, border detection processes may be simplified or assisted.

In a first aspect, a method is provided for three-dimensional cardiac border delineation in medical imaging. A processor receives a view label. A three-dimensional border is detected as a function of the view label.

In a second aspect, a computer readable storage medium has stored therein data representing instructions executable by a programmed processor for three-dimensional cardiac border delineation in medical imaging. The instructions are for: labeling a view associated with a medical image representing a portion of a heart, determining an orientation of the heart as a function of the labeling, and delineating a three-dimensional border of the heart as a function of the orientation.

In a third aspect, a medical imaging system is provided for three-dimensional cardiac border delineation in medical imaging. A processor is operable to receive an indication of an orientation relative to an organ of a one- or two-dimensional view of the organ, and operable to detect a three-dimensional border as a function of the orientation. A display is operable to display a representation of the three-dimensional border.

In a fourth aspect, a method is provided for three-dimensional cardiac border delineation in medical imaging. A view represented by a medical image is identified. A three-dimensional border is detected as a function of the identified view and without selection of points.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of a system for three-dimensional cardiac border delineation in medical imaging;

FIG. 2 is a graphical representation of one embodiment of a heart and associated imaging plane;

FIG. 3 is a graphical representation of one embodiment of a two-dimensional image of the heart; and

FIG. 4 is a flow chart of one embodiment of a method for three-dimensional cardiac border delineation in medical imaging.

### DETAILED DESCRIPTION OF THE DRAWINGS AND PRESENTLY PREFERRED EMBODIMENTS

Automated border detection with or without segmentation of the heart uses a view label. For example, a view from a single or multi-planar reconstruction of the heart is identified. The view is used to assist in determining the heart border. For example, if it is known that a particular two-dimensional image is an apical four-chamber view, than it is possible to determine an orientation of the heart. Knowing the orientation may assist detection of the three-dimensional heart border. As another example, a particular two-dimensional border detection algorithm may be applied based on the view. The two-dimensional border is then used to determine a three-dimensional border.

A medical imaging cardiac motion example is used herein. The system, methods and instructions herein may instead or additionally be used for other border detection, such as detection of three-dimensional borders for other organs.

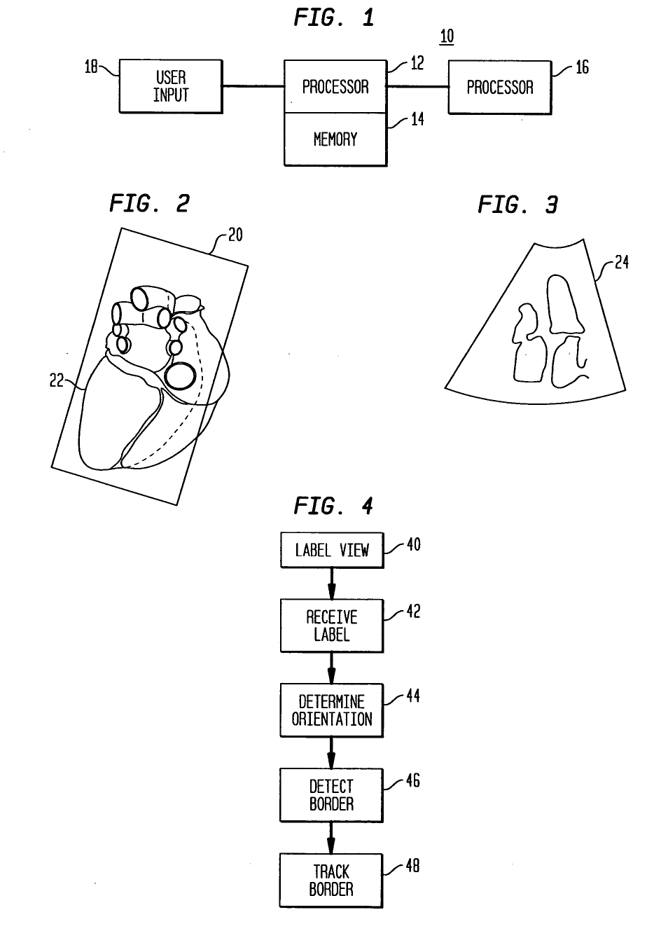

FIG. 1 shows a system 10 for three-dimensional cardiac border delineation in medical imaging. The system 10 includes a processor 12, a memory 14, a display 16, and a user input 18. Additional, different or fewer components may be provided. In one embodiment, the system 10 is a medical diagnostic imaging system, such as an ultrasound therapy or diagnostic imaging system. The system 10 determines one or more borders of the heart while or after images representing a patient's heart are acquired. In other embodiments, the system 10 is a computer, workstation or server. For example, a local or remote PACs workstation receives images and characterizes cardiac motion. In other embodiments, the system 10 is another medical imaging system, such as an MR, CT, PET, angiography, or nuclear medicine imaging system.

The memory 14 is a computer readable storage media. Computer readable storage media include various types of volatile or non-volatile storage media, including but not limited to random access memory, read-only memory, programmable read-only memory, electrically programmable read-only memory, electrically erasable read-only memory, flash memory, magnetic tape or disk, optical media, database, and the like. The memory 14 may include one device or a network of devices with a common or different addressing scheme. In one embodiment, a single memory 14 stores image data, domain knowledge, a classifier and instructions for operating the processor 12, but separate storage may be provided for one or more types of data. The memory 12 may or may not include one or more types of data, such as not including domain knowledge and/or classifiers.

The memory 14 stores data representing instructions executable by a programmed processor, such as the processor 12, for detecting the three-dimensional border. The automatic or semiautomatic operations discussed herein are implemented, at least in part, by the instructions. In one embodiment, the instructions are stored on a removable media drive for reading by a medical diagnostic imaging system or a workstation. An imaging system or workstation uploads the instructions. In another embodiment, the instructions are stored in a remote location for transfer through a computer network or over telephone communications to the imaging system or workstation. In yet other embodiments, the instructions are stored within the system 10 on a hard drive, random access memory, cache memory, buffer, removable media or other device.

The memory 14 stores medical image data for or during processing by the processor 12. For example, the memory 12 includes a database of data sets representing volumes including an organ, such as the heart. Each data set is associated with a different scan of a same or different source or patient. The data sets represent a plurality of different hearts and/or heart conditions. The data is ultrasound or other medical imaging data, such as a sequence of B-mode and/or Doppler data sets. Each data set is formatted in a three-dimensional grid, along a plurality of parallel or non-parallel planes, or other spatial distributions.

Each data set represents a same or different portion of a heart cycle as other data sets. In one embodiment, each data set represents a sequence of volume scans through a portion of or an entire heart cycle. The sequence of images represents a heart as a function of time. The images are stored in a CINE loop, DICOM or other format. In alternative embodiments, the memory 14 does not store data sets other than data currently being processed or data associated with a patient or examination.

The memory 14 stores domain knowledge or data representing pre-identified borders for each of the data sets. Experts, such as doctors or sonographers indicate a border or borders for each data set. Alternatively, an automatic algorithm or an expert assisted algorithm is used to pre-identify the borders. Different or the same algorithms or experts may have identified the borders in the different data sets. The borders may be an average or other combination of borders identified for a same data set by different algorithms or experts. The stored borders are a mesh, three-dimensional surface, or other specification of a border in a volume. For the cardiac example, the borders represent the heart walls (e.g., inner and/or outer walls), a chamber, a portion of the heart, the valves, veins, arteries, and/or other heart structure. In alternative embodiments, pre-identified borders are not provided.

The memory 14 or a different memory includes a current data set, such as associated with a patient or heart being diagnosed. The data set is formatted in a same format as the data sets of the database. Alternatively, a different format is used with or without conversion to the format of the data sets of the database.

The processor 12 is one or more general processors, digital signal processors, application specific integrated circuits, field programmable gate arrays, servers, networks, digital circuits, analog circuits, combinations thereof, or other now known or later developed device for delineating a border. The processor 12 implements a software program, such as code generated manually (i.e., programmed) or a trained or training classification system.

The functions, acts or tasks illustrated in the figures or described herein are performed by the programmed processor 12 executing the instructions stored in the memory 14 or a different memory. The functions, acts or tasks are independent of the particular type of instructions set, storage media, processor or processing strategy and may be performed by software, hardware, integrated circuits, film-ware, micro-code and the like, operating alone or in combination. Likewise, processing strategies may include multiprocessing, multitasking, parallel processing and the like.

The processor 12 implements any now known or later developed algorithm operable to detect a border for the current data set. The processor 12 receives an indication of an orientation relative to an organ of a one- or two-dimensional view of the organ. For example, the processor 12 receives an indication that a currently displayed or previously selected image or plane is a particular type of view, such as an apical four-chamber view. The view label indicates an orientation of the data set relative to the heart (e.g., indicates where the top, bottom or other location of the heart is relative to the scanned volume). The indication is received through manual input on the user input 18 or through processing by the processor 12 or another processor.

The processor 12 is operable to detect a three-dimensional border as a function of the orientation or view label. For example, the orientation or view label limits the search for a similar data set from the database, such as by limiting a relative rotation for pattern matching. The processor 12 searches the database for a data set most or sufficiently similar to the current data set. As another example, an algorithm to be applied for detecting the border is selected based on the view label. The border in two dimensions is detected in a current two-dimensional image based on the view label. The two-dimensional border is then used to determine the three-dimensional border. Other algorithms using the orientation or view label may be used.

The border is detected for data representing a given time. The border may be separately detected for each of a plurality of different times in a heart cycle. Alternatively or additionally, the detected border is tracked through a sequence.

The processor 12 outputs the detected three-dimensional border or borders. The output is to the memory 14, a different memory, another process implemented by the processor 12, or another processor. Alternatively or additionally, the output is to the display 16. A mesh, rendering of the three-dimensional border, planar reconstruction of a section of the border or other representation of the border is output. The border is shown alone or overlaid on one or more images.

The user input device 18 is a keyboard, buttons, sliders, knobs, mouse, trackball, touch pad, touch screen, combinations thereof or other now known or later developed input device. The user input device 18 receives inputs controlling operation of the processor 12 or for use by the processor 12. For example, the user initiates three-dimensional imaging and/or border detection by depressing a button or otherwise indicating with the user input device 18. As another example, the user selects one or more cut planes associated with a volume and/or positions the cut planes. FIG. 2 shows a three-dimensional representation of a heart 22. A cut plane 20 is positioned relative to the heart 22. The user may rotate and/or scale the heart 22 or cut plane 20 relative to each other to provide a desired view of the heart. Additional cut-planes, such as two additional orthogonal cut-planes, may also be provided. FIG. 3 shows the two-dimensional image 24, such as an apical four-chamber view, associated with the cut plane 20. As another example, the user input device 18 receives input for navigating or rendering two-dimensional images or three-dimensional representations.

FIG. 4 shows a method for three-dimensional cardiac border delineation in medical imaging. Although this approach is intended for echocardiography, the method or workflow may be used for other modalities which image the heart or other organs. The method is implemented by the system 10 of FIG. 1 or a different system. Each act is performed automatically with a processor, manually or with manual input. For example, the acts are completely automated, such as the system automatically delineates the endocardial and epicardial surface of the heart given a data set representing the heart. The acts are performed in the order shown or a different order. Additional, different or fewer acts may be provided.

Data representing a three-dimensional volume at one time (i.e., 3D data) or over a period of time (i.e., 4D data) is acquired. The data is acquired by scanning a heart with ultrasound or other energy. Alternatively, cardiac data is collected by transfer from a storage system, such as a PACS system or other storage media.

One or more views of the heart are generated from the data. A single or multi planar format display is generated. A volumetric representation of the heart may or may not also be rendered with at least one image for a plane of the heart. Other renderings of a view of the current data may be used. Current is used for the data to be presently used for diagnosis. This current data may be real-time, such as currently acquired, or may be from a previously performed scan.

In act 40, the view is labeled. The view associated with a medical image representing a portion of a heart is identified and labeled in one example embodiment. The view corresponds to a two-dimensional view of the heart. For example, the view label is a four-chamber view, a three-chamber view, a two-chamber view, an apical view, a parasternal view or combinations thereof. Apical two chamber, apical four chamber, parasternal long axis and parasternal short axis are four possible views, but other now known or later developed views may be labeled. Alternatively, the view corresponds to a one-dimensional view, such as associated with an M-mode image with a scan line extending between two known points in the heart, such as an apex and a valve.

The view is labeled by an algorithm implemented by a processor in one embodiment. Automatic view identification is performed by a same processor for detecting a border or a different processor. In one embodiment, the user selects an image for labeling. Alternatively, the processor automatically selects a plane or image. The view of the heart represented by the image is automatically determined. For example, a classifier extracts one or more features. Based on the features and a trained classification system, the view is classified. Some embodiments of a classifier approach are shown in U.S. Application Publication No. 2005/0251013 (“Systems and Methods for Providing Automated Decision Support in Medical Images” by S. Krishnan et al.), the disclosure of which is incorporated herein by reference. Modeling, matching or other approaches may be used to identify the view with a processor. For example, images representing a plurality of known views are correlated with a selected image. If a sufficient correlation is provided to one of the known views, the label of the known view is associated with the selected image.

The view is labeled by a user in another embodiment. The user inputs the view label for the selected image. For example, the user positions a scanner, such as an ultrasound transducer, relative to the patient to provide a desired view as the selected view. The user then selects a view label from a menu of possible labels. The user may alternatively type in the view label or a code for the view label. In another example, the user manipulates a position of a plane relative to the data to provide any desired view in a group of views. The user indicates which view is selected. As another example, the user provides the view label for a selected image without user manipulation of the plane or line associated with the image.

In other embodiments, the view is labeled by a user with an indication associating a pre-selected view with data. For example, the user is asked to select a pre-specified plane of the heart, such as manipulating a particular cut-plane to show a four-chamber view. The user indicates that the particular cut-plane represents the pre-specified view. Depressing the button or other user activation indicates that a current planar reconstruction is of the pre-selected view. As another example, the user positions the patient and/or scanner to provide the pre-specified view. The user may be instructed, during acquisition, to start with a particular view. Often during three-dimensional data acquisition, the user starts in a two-dimensional mode, selects a view (e.g., apical four chamber view), and then switches to three-dimensional data acquisition. The plane located in the two-dimensional mode is of the pre-selected particular view. That plane can be recorded and used as the orientation to detect a three-dimensional border. The activation of acquisition, such as activating a volume scan (e.g., depress a button or alter a switch), indicates that the current view is the pre-specified view. Alternatively, the user inputs the starting view after or before acquisition. The pre-specified view may be pre-specified by the user or programmed before, after or during an examination, or otherwise supplied.

In act 42, a processor receives the view label. Where the processor automatically determined the view label, the view label is received as an output of the view identification process. Alternatively, the view label is received as a user input. In other embodiments, the view label is received from memory as a pre-specified view. The processor also receives an indication of the position of a plane or line corresponding to the selected view within the volume represented by the current data set. The indication of the position associates the view label with an orientation of the heart relative to the volume.

Additional views may be labeled. Each view is labeled in the same or different way than other views. For example, the user may select multiple planes, such as associated with the apical four chamber, apical two chamber, and parasternal short axis. The data for the selected planes is sent to the algorithm, and the system may automatically recognize the view or the user provides the view label. The system uses one, a subset or all the views to assist in computing the three-dimensional border. The orientation of the heart may be more accurately estimated from establishing the locations of multiple views.

In act 44, the orientation of the heart represented by the data set is determined. The orientation is determined as a function of the labeling. The view is associated with particular structure in the heart. The structure defines an orientation of the heart relative to the scanned volume. The view label corresponds to the plane or line within the volume used to generate the labeled view. By associating the view with the data set, the orientation of the heart as represented in the data set may be determined.

In act 46, a three-dimensional border is detected as a function of the view label. The identified view or views provide the orientation for detecting the border. The orientation provided by the view label relative to the scanned volume is used without identifying particular tissue, such as valves or a myocardial wall. The border is detected by the algorithm without user or processor selection of particular landmark points. The view is identified without further structural selection or indication. Alternatively, the user and/or processor identify a location of one or more landmark points.

The border is detected from the data set automatically. A three-dimensional contour representing the endocardial border of the left ventricle of the heart, the entire heart border or other portions of the heart is determined with a processor. The determination occurs without further user input. Alternatively, the user may assist the process.

In one embodiment, the three-dimensional border of the heart is delineated as a function of the orientation based on two-dimensional border detection. The border of the heart is determined from the labeled view or another view identified by the algorithm based on the labeled view. The algorithm applied may be different for different views. The two-dimensional border and the orientation are used to determine the three-dimensional border. For example, a three-dimensional model is positioned based on the orientation and morphed to the two-dimensional border. As another example, the two-dimensional borders for a plurality of views are used to generate a mesh as the three-dimensional border. In another example, the three-dimensional border is extrapolated from the two-dimensional border based on the orientation. The data set may be used for morphing or adjusting the detection of the three-dimensional border.

In another embodiment, the three-dimensional border is detected by searching for a stored border from a database as a function of the orientation and current data representing the volume. The current data set is correlated with stored data sets. For the correlation, different searches are performed to maximize or increase the correlation. The current data set is rotated with or without scaling relative to each of the stored data sets. The highest correlation between the current data set and each stored data set is determined. To reduce computations, the orientation provided by the view label limits the search. The range, step size, search pattern, initial starting position for the search or combinations thereof of relative rotation is limited or set based on the orientation information. The position of the heart represented by the current data set is aligned with the heart represented by the stored data set using the orientation, more likely correlating the stored data. The orientation may be used to limit one, two or three degrees of freedom in the searching. Alternatively, the orientation is assumed accurate, and searching is not used or only includes scaling.

The stored data set with the highest correlation or sufficiently similar with the current data set is selected. The expert defined or stored three-dimensional border corresponding to the stored data set is selected as the three-dimensional border for the current data set.

In an alternative embodiment, a two-dimensional border determined for the current data set is correlated with stored two-dimensional borders. A stored three-dimensional border corresponding to the stored two-dimensional border at the label based orientation with a sufficient similarity or highest correlation is identified. Alternatively, a three-dimensional border is derived from the current data set, such as using thresholding, region growing or other processes. The derived border is correlated with stored three-dimensional borders as a function of the orientation. The stored border with the highest correlation or a sufficiently similar border is used to refine or replace the derived three-dimensional border.

In another alternative embodiment, the search is between stored three-dimensional borders and the current data set. The orientation limits or sets the search. The stored border with the highest correlation or sufficiently similar to the current data set is selected as the three-dimensional border of the current data set.

The embodiments disclosed in U.S. Application Publication No. ______ (Ser. No. 11/265,772, filed Nov. 2, 2005, by B. Gerogescu et al., “Database-Guided Segmentation of Anatomical Structures with Complex Appearance”), the disclosure of which are incorporated herein by reference, may be used. Data for the anatomical structure of interest (i.e., the current data set) is compared to a database of images of like anatomical structures. The images in the database can carry associated patient information such as demographic, clinical, genetic/genomic/proteomic and/or other information. Those database images of like anatomical structures that are similar to the current data set are identified. The orientation may be used to limit searching for the similarities of structure or data. A similarity measure is defined in terms of image features, such as intensity pattern or its statistics, or other associated information such as demographic, clinical, genetic/genomic/proteomic information, or both. The identified database images or trained classifiers are used to detect the anatomical structure of interest in the current data set. The identified database images are used to determine the shape of the anatomical structure of interest. Other now known or later developed algorithms for detecting the three-dimensional border as a function of the orientation may be used.

The selected three-dimensional border may be altered to account for differences in the current data set. For example, morphing or other processes may be performed to make the border more accurately represent the current data set. Data gradients or correlation-based alterations may be used to morph the border.

In optional act 48, the three-dimensional border is tracked over time as a function of the view label. The three-dimensional border correlated with subsequent sets of data or each subsequent three-dimensional border is correlated with data representing the volume at a later time. Alternatively, motion information is used to track the border. The view label or other orientation information may be used to determine the initial border only or also be used for limiting searches for subsequent borders. In other embodiments, the three-dimensional border is determined separately for each volume representing the heart at a different time.

The three-dimensional border or borders are displayed in one embodiment. A mesh, series of contours or other surface is rendered for a three-dimensional representation. A two-dimensional border corresponding to a planar view may also be generated. The borders are displayed alone or overlay an image generated from the data set. Alternatively or additionally, the border is used for quantification, such as defining a volume or other measurement related parameter. The quantifications are displayed or used for further processing, such as being used for classifying heart operation. In other embodiments, the border is segmented manually or automatically and used to diagnosis heart operation.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (We) claim:

1. A method for three-dimensional cardiac border delineation in medical imaging, the method comprising:
receiving, with a processor, a view label; and
detecting a three-dimensional border as a function of the view label.

2. The method of claim 1 wherein receiving comprises receiving the view label corresponding to a two-dimensional view of a heart.

3. The method of claim 2 wherein receiving comprises receiving the view label as a four chamber view, a three chamber view, a two chamber view, an apical view, a parasternal view or combinations thereof.

4. The method of claim 3 wherein receiving comprises receiving the view label as an apical, four chamber view.

5. The method of claim 1 wherein receiving comprises receiving a user input of the view label.

6. The method of claim 1 wherein receiving comprises receiving the view label from an algorithm implemented by the processor or another processor.

7. The method of claim 1 wherein receiving comprises receiving an indication associating a pre-selected view with data.

8. The method of claim 7 further comprising:
generating a planar reconstruction of a volume; and
positioning the planar reconstruction to the pre-selected view of the volume;
wherein receiving comprises receiving the indication that a current planar reconstruction is of the pre-selected view.

9. The method of claim 7 wherein receiving the indication comprises receiving the indication as a begin three-dimensional processing indication.

10. The method of claim 1 further comprising receiving, with the processor, an additional view label for an additional view different from a view for the view label;
wherein detecting comprises detecting the three-dimensional border as a function of the view label and the additional view label.

11. The method of claim 1 wherein the view label corresponds to an orientation of a view within a volume representing an organ, and wherein detecting comprises searching for a stored border from a database as a function of the orientation and data representing the volume.

12. The method of claim 11 wherein detecting comprises selecting the stored border associated with stored data sufficiently matching the data; and further comprising:
morphing the stored border to the data, the morphed stored border being the three-dimensional border.

13. The method of claim 1 further comprising tracking the three-dimensional border over time as a function of the view label.

14. In a computer readable storage medium having stored therein data representing instructions executable by a programmed processor for three-dimensional cardiac border delineation in medical imaging, the storage medium comprising instructions for:
labeling a view associated with a medical image representing a portion of a heart;
determining an orientation of the heart as a function of the labeling; and
delineating a three-dimensional border of the heart as a function of the orientation.

15. The instructions of claim 14 wherein the labeling comprises labeling the view associated with a two-dimensional ultrasound image, the view being a four chamber view, a three chamber view, a two chamber view, an apical view, a parasternal view or combinations thereof.

16. The instructions of claim 14 wherein labeling comprises: receiving a user indication of a view label, receiving the view label from an algorithm, receiving an indication associating the view with a pre-selected view, and combinations thereof.

17. The instructions of claim 14 wherein delineating comprises searching for sufficiently similar stored data to data representing the organ in three-dimensions from a database of potential borders, the searching being as a function of the orientation.

18. A medical imaging system for three-dimensional cardiac border delineation in medical imaging, the system comprising:
a processor operable to receive an indication of an orientation relative to an organ of a one- or two-dimensional view of the organ, and operable to detect a three-dimensional border as a function of the orientation; and
a display operable to display a representation of the three-dimensional border.

19. The medical imaging system of claim 18 further comprising a user input device, the processor operable to receive the indication from the user input device.

20. A method for three-dimensional cardiac border delineation in medical imaging, the method comprising:
identifying a view represented by a medical image;
detecting a three-dimensional border as a function of the identified view and without selection of points.
